(19) United States
(12) Patent Application Publication
(10) Pub. No.: US 2024/0354465 A1
(43) Pub. Date: Oct. 24, 2024

(54) DETERMINING LOCATION AND SIZING OF A NEW POWER UNIT WITHIN A CURRENT SYSTEM ARCHITECTURE OF A POWER SYSTEM OR A GRID

(71) Applicant: Siemens Corporation, Washington, DC (US)

(72) Inventors: Xiaofan Wu, North Brunswick, NJ (US); Ulrich Muenz, Princeton, NJ (US); Suat Gumussoy, Princeton, NJ (US)

(73) Assignee: Siemens Corporation, Washington, DC,, DC (US)

(21) Appl. No.: 18/684,336

(22) PCT Filed: Aug. 30, 2021
(86) PCT No.: PCT/US2021/048192

§ 371 Date: Feb. 16, 2024

(51) Int. Cl. G06F 30/18; G06F 30/27; G06F 111/06; G06F 113/04

(52) U.S. Cl. CPC G06F 30/18; G06F 30/27; G06F 2111/06; G06F 2113/04

(57) ABSTRACT

A system determines a location and a size of a new power generation or power regulating unit within a current system architecture of a power system including a plurality of power generation units. The system comprises a controller including a processor and a memory, computer-readable logic code stored in the memory which, when executed by the processor, causes the controller to execute a hybrid algorithm as a combination of a data-driven algorithm and a model-based algorithm to determine an optimal location and size of the new power generation or power regulating unit. The data-driven algorithm encodes a location and a size information. The controller to enable the model-based algorithm to optimize performance of a selected location and size of the new power generation or power regulating unit, which is based on a linearized system or a nonlinear system to provide guidance for the data-driven algorithm to incorporate physical rules and verify a new system architecture.

### BACKGROUND

### 1. Field

Aspects of the present invention generally relate to determining location and sizing of a new power generation or power regulating unit within a current system architecture of a power system or a power grid.

### 2. Description of the Related Art

Integration and installation of new Distributed Energy Resources (DERs) (like solar farms, wind turbines, energy storage systems, fuel cells, different types of generators, etc.) has become more common and more frequent in recent years. This is largely due to international recognition of the need for renewable energy, greenhouse gas reduction, sustainability targets and so on. Utilities and Independent System Operators (ISOs) are constantly adding more generation units or replacing conventional generators with renewable energy resources. This has a severe impact on the dynamic security of the power system especially if the power system gets close to 100% DER peak generation. Dynamic security of a power system refers to its ability to withstand single failures like a power line or a power plant without power outages. Therefore, utilities and ISOs install additional assets like grid-forming batteries or synchronous condensers to improve the dynamic security of the power system. Throughout this disclosure, we call these assets “grid stabilizers”. Two of the most challenging problems in this process is the allocation and sizing of the new grid stabilizers. The locations and sizes of these new installations are crucial because they can significantly change the dynamics and behavior of the power system, even creating additional challenges for the grid operator to maintain stability and reliability of the system. Moreover, these grid stabilizers are very expensive (high CAPEX) and do not create direct benefits during operation (low OPEX). Hence, utilities and ISOs try to minimize the number and size for grid stabilizers. To minimize CAPEX, the allocation and sizing of both DERs and grid stabilizers have to be optimized together. For simplicity of presentation, the term DER is used for both DERs and grid stabilizers.

Existing systems consider placing the DERs at existing nodes, without considering connecting a new DER at a new node. The optimization objectives are minimizing power loss, cost and load curtailment, enhancing voltage profile, and reliability, improving voltage stability, maximizing profit and reducing purchase. Four types of algorithms that are used: heuristic methods, mathematical programming algorithms, analytical approaches and hybrid algorithm with a combination of the two or several methods aforementioned. None of the existing systems consider dynamic security as an optimization objective to ensure system is stable during N−1 contingencies.

Therefore, there is a need to optimally determine location and sizing of a new power generation or power regulating unit within a current system architecture of a power system or a power grid.

### SUMMARY

Briefly described, aspects of the present invention relate to determining location and sizing of a new power generation or power regulating unit within a current system architecture of a power system or a power grid. The primary objective of present invention is to make sure when new DERs are installed, the power system is still able to maintain resilient against N−1 contingencies, therefore minimizing the chances of power outages. The proposed framework provides the grid planning and operation personnel a way to assess and optimize the resiliency of the future power system with different generation mix and different renewable integration percentages. A linear model is generated for this approach because dynamic security optimization relies on the linear model. A simulation-based verification step is performed and this step usually requires a simulation software and a nonlinear simulation model. The present invention addresses the Dynamic Security Optimization to achieve N−1 security but it does also include the allocation and sizing of assets. A system considers dynamic security as an optimization objective to ensure that the system is stable during N−1 contingencies. Through its modular design, a system offers a wide variety of analysis functions for the planning, design and operation of power systems. For example, a linear model is generated for this approach because dynamic security optimization relies on the linear model. A simulation-based verification step is included, which requires a simulation software and a nonlinear simulation model.

In accordance with one illustrative embodiment of the present invention, a system is configured to determine location and sizing of a new power generation or power regulating unit within a current system architecture of a power system including a plurality of power generation units. The system comprises a controller including a processor and a memory, computer-readable logic code stored in the memory which, when executed by the processor, causes the controller to execute a hybrid algorithm as a combination of a data-driven algorithm and a model-based algorithm to determine an optimal location and size of the new power generation or power regulating unit. The data-driven algorithm encodes a location and a size information. The controller to enable the model-based algorithm to optimize performance of a selected location and size of the new power generation or power regulating unit, which is based on a linearized system or a nonlinear system to provide guidance for the data-driven algorithm to incorporate physical rules. The controller to verify a new system architecture with the new power generation or power regulating unit installation and optimized control parameters to ensure the power system is stable and reliable so that the system can endure a single point failure.

In accordance with another illustrative embodiment of the present invention, a method is provided for determining location and sizing of a new power generation unit within a current system architecture of a power system comprising a plurality of power generation units. The method comprises providing a controller including a processor and a memory, and providing computer-readable logic code stored in the memory which, when executed by the processor, causes the controller to iteratively loop between a Reinforcement Learning (RL)-based asset allocation and sizing algorithm which is a data-driven approach and a Dynamic Security Optimization (DSO) algorithm which is a model-based approach to search for an optimal solution via a hybrid approach as a combination of the data-driven approach and the model-based approach such that results of the optimal solution are then verified by a power system nonlinear simulator. The RL-based asset allocation and sizing algorithm encodes a location and size information in a graph-based representation. The RL-based asset allocation and sizing algorithm also incorporates expert knowledge not only for initial selections but allows a workflow that guides the RL-based asset allocation and sizing algorithm to desired locations and size when they are hard to encode. The controller to enable the DSO algorithm which is based on a linearized system to provide guidance for the RL-based asset allocation and sizing algorithm to follow physical rules. The controller to verify a new system architecture with the new power generation unit installation and optimized control parameters to ensure the power system is stable and reliable during all types of N−1 contingencies so that the power system can endure a single point failure.

In accordance with one illustrative embodiment of the present invention, a system is configured to determine location and sizing of a new power generation unit within a current system architecture of a power system comprising a plurality of power generation units. The system comprises a controller including a processor and a memory, and computer-readable logic code stored in the memory which, when executed by the processor, causes the controller to iteratively loop between a Reinforcement Learning (RL)-based asset allocation and sizing algorithm which is a data-driven approach and a Dynamic Security Optimization (DSO) algorithm which is a model-based approach to search for an optimal solution via a hybrid approach as a combination of the data-driven approach and the model-based approach such that results of the optimal solution are then verified by a power system nonlinear simulator. The RL-based asset allocation and sizing algorithm encodes a location and size information in a graph-based representation. The RL-based asset allocation and sizing algorithm also incorporates expert knowledge not only for initial selections but allows a workflow that guides the RL-based asset allocation and sizing algorithm to desired locations and size when they are hard to encode. The controller to enable the DSO algorithm which is based on a linearized system to provide guidance for the RL-based asset allocation and sizing algorithm to follow physical rules. The controller to verify a new system architecture with the new power generation unit installation and optimized control parameters to ensure the power system is stable and reliable during all types of N−1 contingencies so that the power system can endure a single point failure.

### BRIEF DESCRIPTION OF THE DRAWINGS

FIG. 1 illustrates a block diagram of a system configured to determine location and sizing of a new power generation or power regulating unit within a current system architecture of the system including a plurality of power generation units in accordance with an exemplary embodiment of the present invention.

FIG. 2 illustrates an overview of a proposed methodology in accordance with an exemplary embodiment of the present invention.

FIG. 3 illustrates a reinforcement learning (RL)-based asset allocation and sizing algorithm in accordance with an exemplary embodiment of the present invention.

FIG. 4A-4C illustrate a dynamic security optimization (DSO) algorithm in accordance with an exemplary embodiment of the present invention.

FIG. 5 illustrates a power system nonlinear simulator in accordance with an exemplary embodiment of the present invention.

FIG. 6 illustrates a process workflow of asset allocation and sizing for dynamic secure power systems in accordance with an exemplary embodiment of the present invention.

FIG. 7 illustrates a logic code including a Reinforcement Learning (RL)-based asset allocation and sizing algorithm engine and a Dynamic Security Optimization (DSO) algorithm engine that handle a new DER installation request to determine a location and a size of the new DER in accordance with an exemplary embodiment of the present invention.

FIG. 8 illustrates a schematic view of a flow chart of a method of determining location and sizing of a new power generation unit within a current system architecture of a system comprising a plurality of power generation units in accordance with an exemplary embodiment of the present invention.

FIG. 9 shows an example of a computing environment within which embodiments of the disclosure may be implemented.

### DETAILED DESCRIPTION

To facilitate an understanding of embodiments, principles, and features of the present invention, they are explained hereinafter with reference to implementation in illustrative embodiments. In particular, they are described in the context of a system that is configured to determine location and sizing of a new power generation or power regulating unit within a current system architecture of the system including a plurality of power generation units. Embodiments of the present invention, however, are not limited to use in the described devices or methods.

The components and materials described hereinafter as making up the various embodiments are intended to be illustrative and not restrictive. Many suitable components and materials that would perform the same or a similar function as the materials described herein are intended to be embraced within the scope of embodiments of the present invention.

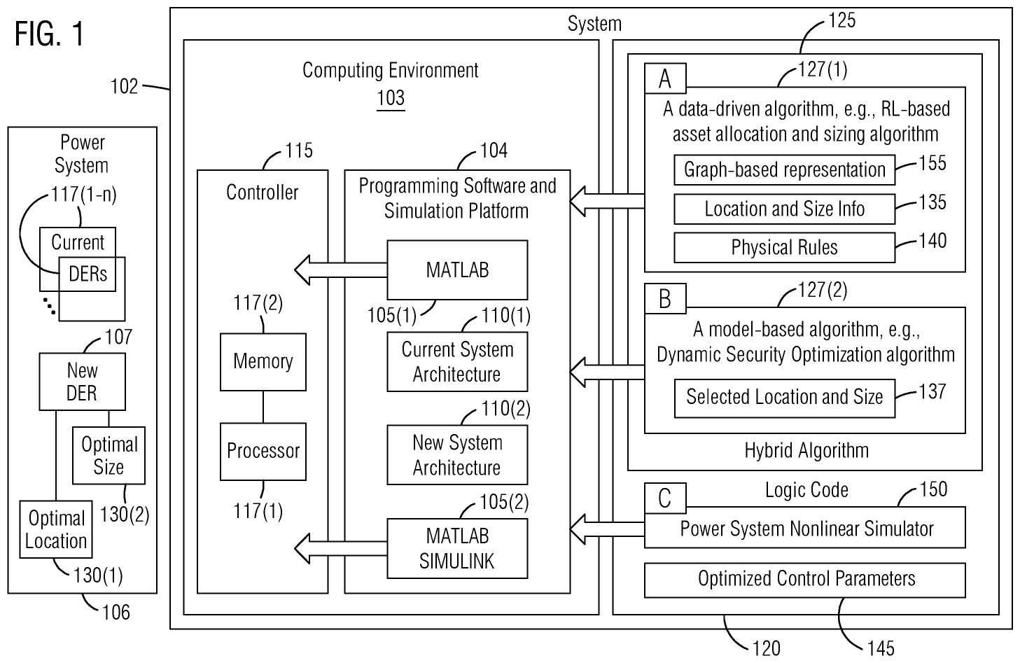

These and other embodiments of a system for asset allocation and sizing for dynamic secure power systems according to the present disclosure are described below with reference to FIGS. 1-7 herein. Like reference numerals used in the drawings identify similar or identical elements throughout the several views. The drawings are not necessarily drawn to scale.

Consistent with one embodiment of the present invention, FIG. 1 represents a block diagram of a system 102 for asset allocation and sizing for dynamic secure power systems in accordance with an exemplary embodiment of the present invention. The system 102 comprises a computing environment 103 and a programming software and simulation platform 104. The programming software and simulation platform 104 comprises MATLAB 105(1) and SIMULINK 105(2). MATLAB 105(1) and SIMULINK 105(2) are one example of the programming software and simulation platform 104.

A dynamic secure power system can maintain stability after N−1 contingency. In other words, a power system that is able to withstand at all times an unexpected failure or outage of a single system component, has an acceptable reliability level. The system 102 considers dynamic security as an optimization objective to ensure the system 102 is stable during N−1 contingencies. An N−1 contingency is a sequence of events consisting of a loss of a single generator or a transmission component in a grid. An N−1 contingency analysis is performed to assure secure operation of a grid while controlling the active power flow. The primary objective of the present invention is to make sure when new Distributed Energy Resources (DERs) are installed, a power system is still able to maintain resilient against N−1 contingencies, therefore minimizing the chances of power outages. The proposed framework provides a grid planning and operation personnel a way to assess and optimize the resiliency of a future power system with different generation mix and different renewable integration percentages.

The system 102 is configured to determine location and sizing of a new power generation or power regulating unit such as a new Distributed Energy Resource (DER) 107 within a current system architecture 110(1) of a power system 106 including a plurality of power generation units such as a plurality of Distributed Energy Resources (DERs) 107(1-n) in accordance with an exemplary embodiment of the present invention. Examples of the plurality of Distributed Energy Resources (DERs) 107(1-n) include solar farms, wind turbines, energy storage systems, fuel cells, and different types of generators, etc.

The computing environment 103 comprises a controller 115 including a processor 117(1) and a memory 117(2). The system 102 further comprises computer-readable logic code 120 stored in the memory 117(2) which, when executed by the processor 117(1), causes the controller 115 to execute a hybrid algorithm 125 as a combination of a data-driven algorithm 127(1) and a model-based algorithm 127(2) to determine an optimal location 130(1) and an optimal size 130(2) of the new DER 107. The data-driven algorithm 127(1) encodes location and size information 135. The computer-readable logic code 120 comprises programmable and executable software instructions.

The computer-readable logic code 120 when executed by the processor 117(1) further causes the controller 115 to enable the model-based algorithm 127(2) to optimize performance of a selected location and size 137 of the new DER 107, which is based on a linearized system or a nonlinear system to provide guidance for the data-driven algorithm 127(1) to incorporate a plurality of physical rules 140. Examples of the physical rules 140 include power flow constraints, protection device requirements, operational limit, transient behavior, and any other characteristics of the system 102 that are not captured in a linearized model. The computer-readable logic code 120 when executed by the processor 117(1) further causes the controller 115 to verify a new system architecture 110(2) with the new DER 107 installation and optimized control parameters 145 to ensure the power system 106 is stable and reliable so that the power system 106 can endure a single point failure.

The computer-readable logic code 120 comprises a power system nonlinear simulator 150 to build up a nonlinear simulation of the power system 106. The model-based algorithm 127(2) is configured to derive a corresponding linearized system.

The computer-readable logic code 120 stored in the memory 117(2) which, when executed by the processor 117(1), causes the controller 115 to iteratively loop between a Reinforcement Learning (RL)-based asset allocation and sizing algorithm which is a data-driven approach and a Dynamic Security Optimization (DSO) algorithm which is a model-based approach to search for an optimal solution via a hybrid approach as a combination of the data-driven approach and the model-based approach such that results of the optimal solution are then verified by the power system nonlinear simulator 150.

The RL-based asset allocation and sizing algorithm encodes a location and size information in a graph-based representation 155. The RL-based asset allocation and sizing algorithm also incorporates the physical rules 140 not only for initial selections but allows a workflow that guides the RL-based asset allocation and sizing algorithm to desired locations and size when they are hard to encode. The controller 115 to enable the DSO algorithm which is based on a linearized system to provide guidance for the RL-based asset allocation and sizing algorithm to follow the physical rules 140. The controller 115 to verify the new system architecture 110(2) with the new DER 107 and the optimized control parameters 145 to ensure the power system 106 is stable and reliable during all types of N−1 contingencies so that the power system 106 can endure a single point failure.

In operation, the processor 117(1) to execute a model-based algorithm engine without new assets including the new DER 107. The model-based algorithm engine to send updated models and results of the model-based algorithm to a data-driven algorithm engine. The processor 117(1) to execute the data-driven algorithm engine with a graph-based representation to determine optimal asset locations and sizing incorporating the expert knowledge. The data-driven algorithm engine sends an optimized asset location and sizing to the model-based algorithm engine. The processor 117(1) executes the model-based algorithm engine with new asset locations and sizing. The processor 117(1) to send the optimized control parameters 145 to the power system nonlinear simulator 150 for simulation and verification. The processor 117(1) to simulate a nonlinear system and send results with system status information back to the model-based algorithm engine.

A combination of two techniques is provided to solve power system assets allocation and sizing problem in that a reinforcement learning and graph-based optimization framework to determine candidate location and sizing and a dynamic security optimization of power system to guarantee system is resilient against N−1 contingencies. In other words, the system 102 integrates the tasks of stability study and controller tuning (which usually happens during commissioning) into the system designing phase. The system 102 considers resiliency and dynamic security conditions when designing DER locations and sizes.

A hybrid (data-driven+model-based) approach provides more realistic and feasible optimization results compared to pure data-driven approaches. On the one hand, reinforcement learning approach finds the optimal solution without simplifying assumptions, combining prior knowledge and both simulation and real data. On the other hand, dynamic security optimization and nonlinear simulation verification are important model-based steps to set the physical constraints for an optimization problem and provide a sanity check.

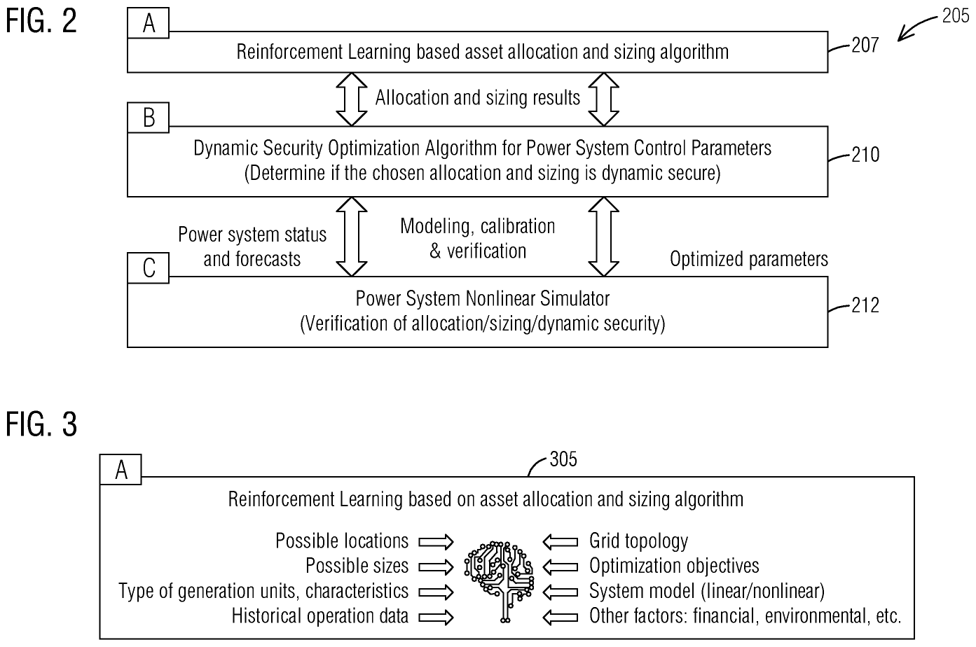

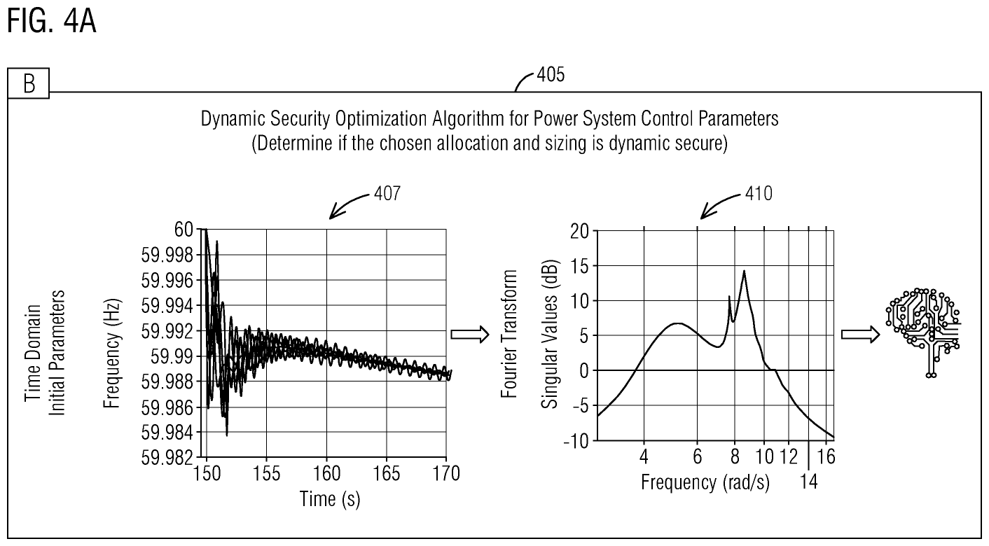

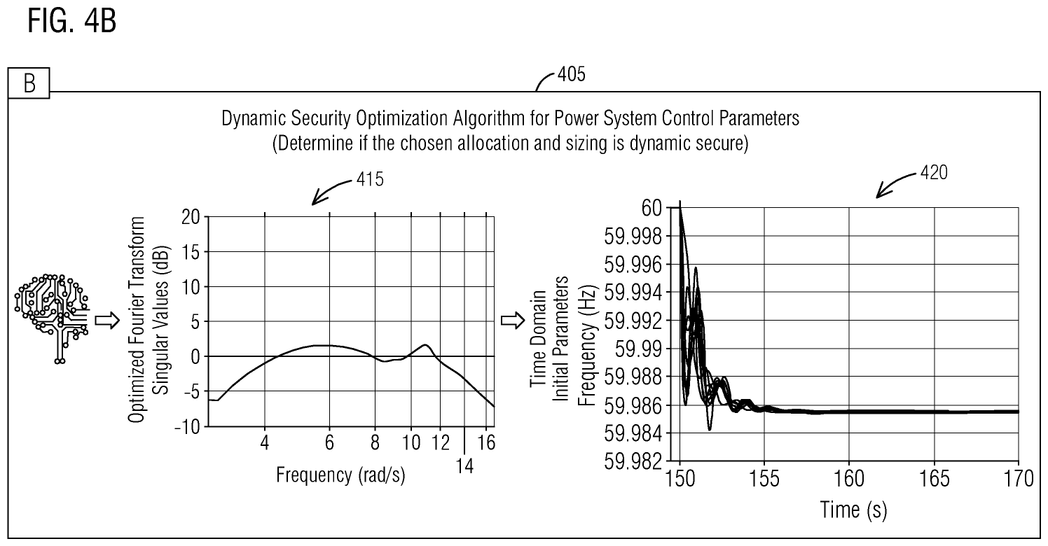

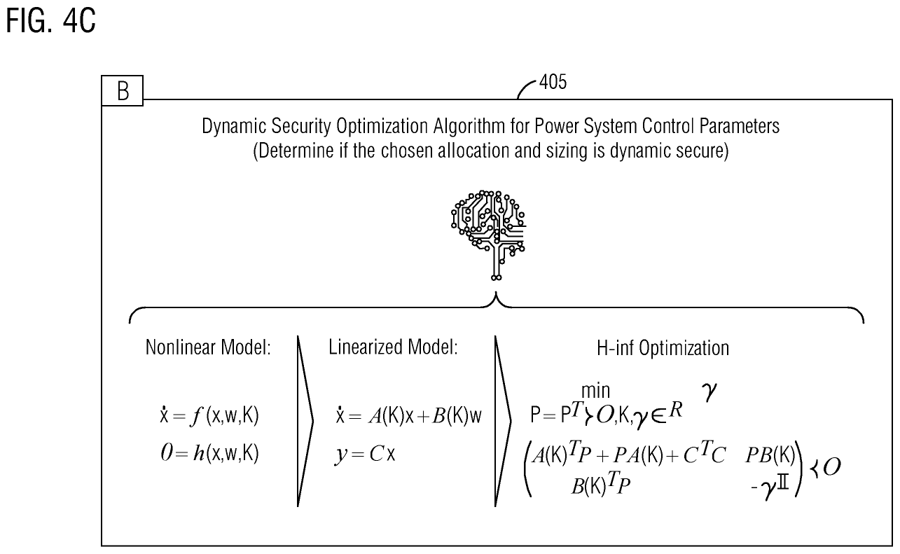

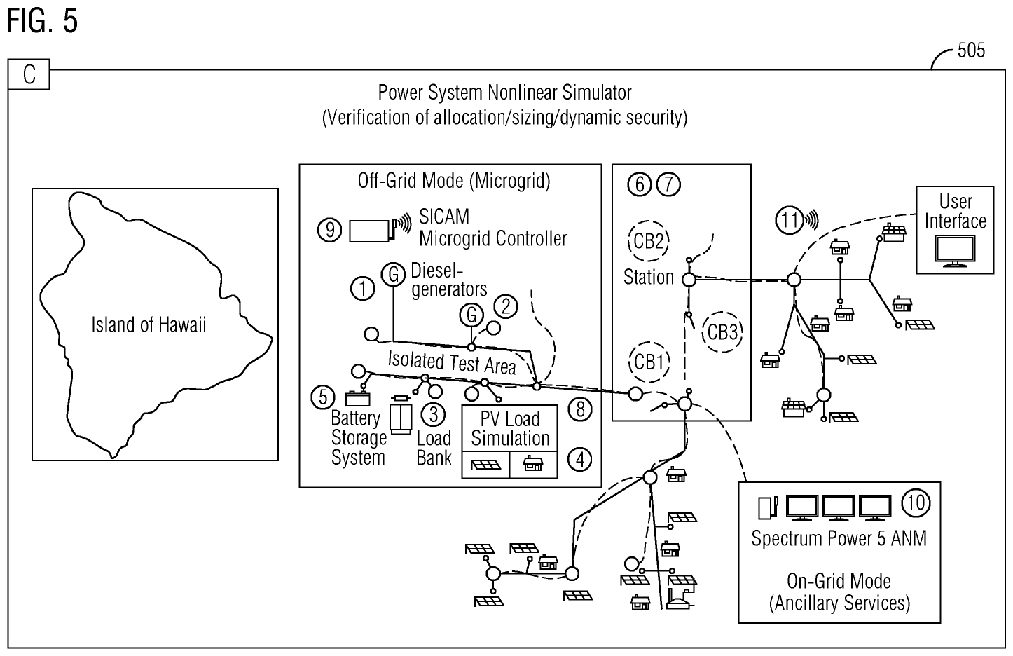

Referring to FIG. 2, it illustrates an overview of a proposed methodology 205 in accordance with an exemplary embodiment of the present invention. The proposed methodology 205 comprises a reinforcement learning (RL)-based asset allocation and sizing algorithm 207 as further shown in FIG. 3, a dynamic security optimization (DSO) algorithm 210 as further shown in FIGS. 4A-4C and a power system nonlinear simulator 212 as further shown in FIG. 5.

A, B and C represent the three main components of the proposed methodology 205. The core innovation is the interconnection between these three components A, B, and C. They provide necessary data for each other and also constraint each other to make sure the final solution is optimal.

The reinforcement learning (RL)-based asset allocation and sizing algorithm 207 utilizes RL techniques over graphs and solves the location and sizing of the new DER 107 for the following challenges:

Possible locations and sizes: The underlying optimization problem have discrete (location) and continuous (size) variables.

Type of generation for the new DER 107 and its characteristics: The assets have different characteristics (grid-forming, grid-following, fast response, slow response, etc.) which makes the optimization problem difficult.

System information (model, topology, etc.): The model has dynamics and certain topology structure. The reinforcement learning (RL)-based asset allocation and sizing algorithm 207 incorporates this dynamics and topology structure.

Historical operation data (e.g., Phasor Measurement Unit (PMU)/Remote Terminal Unit (RTU) data, event logs, operator notes, etc.): The reinforcement learning (RL)-based asset allocation and sizing algorithm 207 uses prior knowledge to learn faster and real measurement data to balance the synthetic simulation data.

Financial and environmental impact: The reinforcement learning (RL)-based asset allocation and sizing algorithm 207 not only considers the financial aspect but also takes into the account of environmental impact.

N−1 contingencies analysis: Asset allocation and sizing by the reinforcement learning (RL)-based asset allocation and sizing algorithm 207 includes stability analysis so that the power system 106 can endure a single point failure.

The reinforcement learning (RL)-based asset allocation and sizing algorithm 207 enables the system 102 to perform financial and environmental decision-making for robust asset allocation and sizing with discrete/continuous choices over internal dynamics model and topological structures utilizing previous knowledge and data. It utilizes reinforcement learning techniques focusing on a mixed-type optimization with graph structure and specialized on power system with DER.

The dynamic security optimization (DSO) algorithm 210 is provided for optimization of power system control parameters: in this step, the system 102 solves dynamic security optimization problem to make sure the power system 106 with new DERs 107 can withstands almost all N−1 contingencies (loss of any powerline, transformer, or generator) without major load shedding or a complete blackout of the system.

The power system nonlinear simulator 212: in this step, the system 102 verifies the new system architecture 110(2) with the new DER 107 installations and optimized control parameters to make sure the power system 106 is stable and reliable during all types of N−1 contingencies.

Turning now to FIG. 3, it illustrates a reinforcement learning (RL)-based asset allocation and sizing algorithm 305 in accordance with an exemplary embodiment of the present invention. The reinforcement learning (RL)-based asset allocation and sizing is based on: possible locations, possible sizes, type of generation units and characteristics, historical operation data, grid topology, optimization objectives, system model (linear/nonlinear) and/or other factors: financial, environmental, etc.

FIG. 4A-4C illustrates a dynamic security optimization (DSO) algorithm 405 in accordance with an exemplary embodiment of the present invention. Dynamic Security Optimization of power system control parameters determines if the chosen allocation and sizing is dynamic secure.

In this step in FIG. 4A, the system 102 solves a dynamic security optimization problem to make sure the power system 106 with new DERs can withstand almost all N−1 contingencies (loss of any powerline, transformer, or generator) without major load shedding or a complete blackout of the system 106. In these two graphs, a left graph 407 shows that frequency signals of the DERs oscillation are a lot during operation. A right graph 410 shows a frequency domain response that has very significant resonant peaks.

In FIG. 4B, a left graph 415 shows that the resonant peaks of the frequency domain response have been greatly suppressed, compared to the graph from previous FIG. 4A, therefore improving system stability. A right graph 420 shows that frequency signals of the DERs oscillation much less during operation, i.e., oscillations have been damped, compared to the graph from previous FIG. 4A. These two graphs 415, 420 show the effectiveness of the DSO algorithm 405.

FIG. 4C is a mathematical representation of the DSO algorithm 405 on a high level. Details of the DSO algorithm 405 are well known.

As seen in FIG. 5, it illustrates a power system nonlinear simulator 505 in accordance with an exemplary embodiment of the present invention. This is an example of a power system nonlinear simulation component. The simulation can be performed on any power system simulation platform (including software/hardware) that has the capabilities to run simulation with detailed power system models for an entire transmission or distribution system. Such platform include: Simulink, OPAL-RT, RTDS, or any other lab simulation environment that is set up to do so.)

For example, Simulink is a block diagram environment for Model-Based Design. It supports simulation, automatic code generation, and continuous testing of embedded systems. MATLAB® and Simulink® can be used together to combine textual and graphical programming to design a system in a simulation environment. One can directly use the thousands of algorithms that are already in MATLAB. Or simply add MATLAB code into a Simulink block or Stateflow® chart. One can use MATLAB to create input data sets to drive simulation. Also run thousands of simulations in parallel. Then analyze and visualize the data in MATLAB.

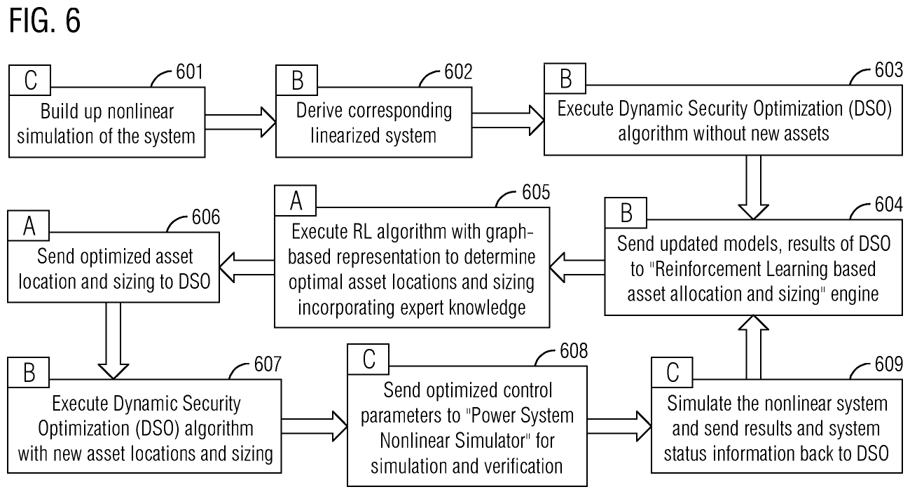

As shown in FIG. 6, it illustrates a process workflow 600 of asset allocation and sizing for dynamic secure power systems in accordance with an exemplary embodiment of the present invention.

Step 601: Build up nonlinear simulation of the system 102.

Step 602: Derive a corresponding linearized system.

Step 603: Execute a Dynamic Security Optimization (DSO) algorithm without new assets.

Step 604: Send updated models, results of the DSO algorithm to a “Reinforcement Learning-based asset allocation and sizing” engine.

Step 605: Execute a RL algorithm with a graph-based representation to determine optimal asset locations and sizing incorporating expert knowledge.

Step 606: Send optimized asset location and sizing to the DSO algorithm.

Step 607: Execute the DSO algorithm with new asset locations and sizing

Step 608: Send optimized control parameters to the “Power System Nonlinear Simulator” 150 for simulation and verification

Step 609: Simulate the nonlinear system and send results and system status information back to the DSO algorithm.

Steps 601-603 are initialization steps that will only run once during the entire process. Steps 604-609 form a loop. This approach iteratives between “RL-based asset allocation and sizing” and “Dynamic Security Optimization” to search for an optimal solution. The RL algorithm encodes the location and size information in a graph-based representation. It also incorporates expert knowledge not only for initial selections but allows an operator to guide the RL algorithm to desired locations and size when they are hard to encode. DSO is based on a linearized system so it is a model-based approach, which provides guidance for the RL algorithm to follow the physical rules 140. Steps 608 and 609 are verification steps based on nonlinear simulation, this is to guarantee the performance of the system 102 and to make sure the solution is feasible and practical.

Steps 605 and 606 are executed by a reinforcement learning (RL)-based asset allocation and sizing algorithm engine. Steps 602-604 and 607 are executed by a Dynamic Security Optimization (DSO) algorithm engine. Steps 601, 608 and 609 are executed by a Power System Nonlinear Simulator engine.

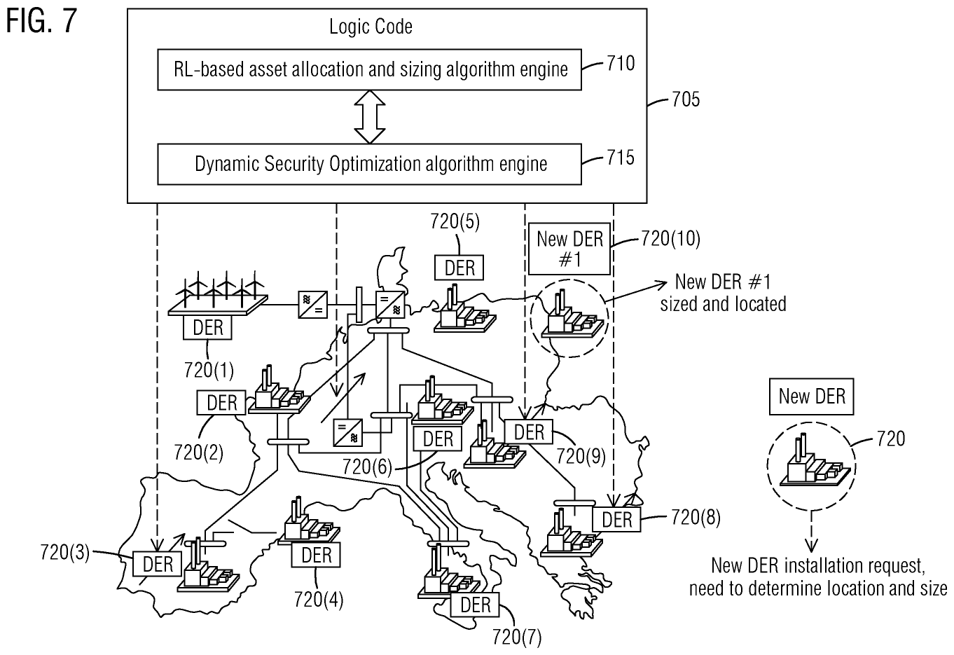

In FIG. 7, it illustrates a logic code 705 including a Reinforcement Learning (RL)-based asset allocation and sizing algorithm engine 710 and a Dynamic Security Optimization (DSO) algorithm engine 715 that handle a new DER 720 installation request to determine a location and a size of the new DER 720 in accordance with an exemplary embodiment of the present invention.

A dynamic secure power system 702 comprises existing DERs 720 (1-9). The new DER 720 is to be located and sized by the logic code 705. A located and sized new DER 720 (10) is shown in FIG. 4.

FIG. 7 shows an example of when the system 102 is used. In a transmission or distribution power system, when a new DER installation request comes in, the system 102 will determine the best size and location of the DER to make sure all requirements are satisfied. In this particular case, a grid operator enters the request of New DER #1 installation in the system 702 with all the requirements. Those requirements could include possible installation sites, stability margins, N−1 contingency types, cost limits, environmental concerns, etc. Then the system 102 executes a hybrid algorithm and propose to install new DER #1 at the northeast corner of the system 702 with proper size.

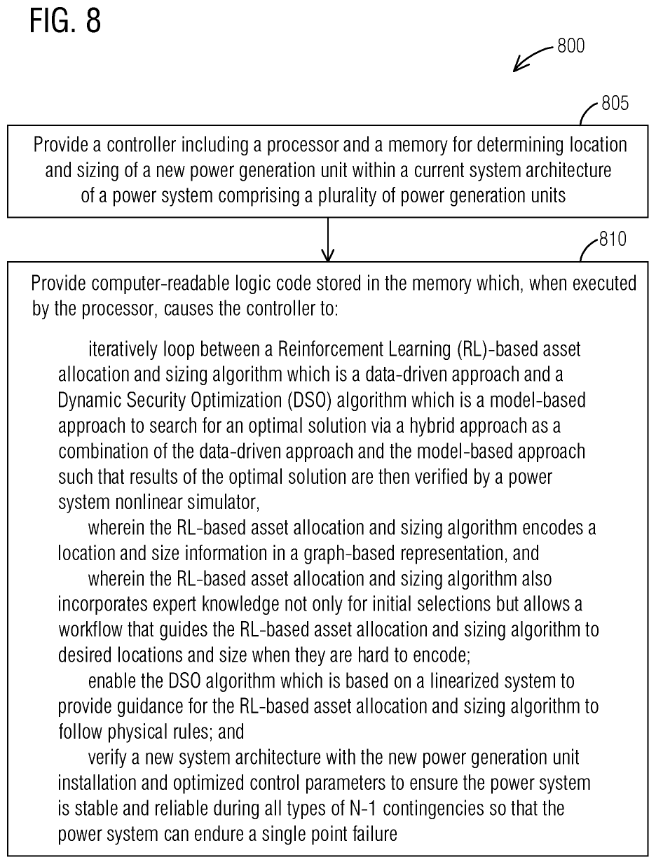

With regard to FIG. 8, it illustrates a schematic view of a flow chart of a method 800 of determining location and sizing of a new power generation unit within a current system architecture of a power system comprising a plurality of power generation units in accordance with an exemplary embodiment of the present invention. Reference is made to the elements and features described in FIGS. 1-7. It should be appreciated that some steps are not required to be performed in any particular order, and that some steps are optional.

The method 800 performed by the system 102 comprises a step 805 of providing a controller including a processor and a memory. The method 800 further comprises a step 810 of providing computer-readable logic code stored in the memory which, when executed by the processor, causes the controller to iteratively loop between a Reinforcement Learning (RL)-based asset allocation and sizing algorithm which is a data-driven approach and a Dynamic Security Optimization (DSO) algorithm which is a model-based approach to search for an optimal solution via a hybrid approach as a combination of the data-driven approach and the model-based approach such that results of the optimal solution are then verified by a power system nonlinear simulator.

The RL-based asset allocation and sizing algorithm encodes a location and size information in a graph-based representation. The RL-based asset allocation and sizing algorithm also incorporates expert knowledge not only for initial selections but allows a workflow that guides the RL-based asset allocation and sizing algorithm to desired locations and size when they are hard to encode.

The controller to enable the DSO algorithm which is based on a linearized system to provide guidance for the RL-based asset allocation and sizing algorithm to follow physical rules. The controller to verify a new system architecture with the new power generation unit installation and optimized control parameters to ensure the power system is stable and reliable during all types of N−1 contingencies so that the power system can endure a single point failure.

While “a RL-based asset allocation and sizing algorithm” and “a DSO algorithm” are described here a range of one or more other algorithms, or other forms of algorithms are also contemplated by the present invention. For example, other types of data-driven or model-based algorithms may be implemented based on one or more features presented above without deviating from the spirit of the present invention.

The techniques described herein can be particularly useful for power generation or power regulating units. While particular embodiments are described in terms of the power generation or power regulating units, the techniques described herein are not limited to power generation or power regulating units but can also be used with other systems.

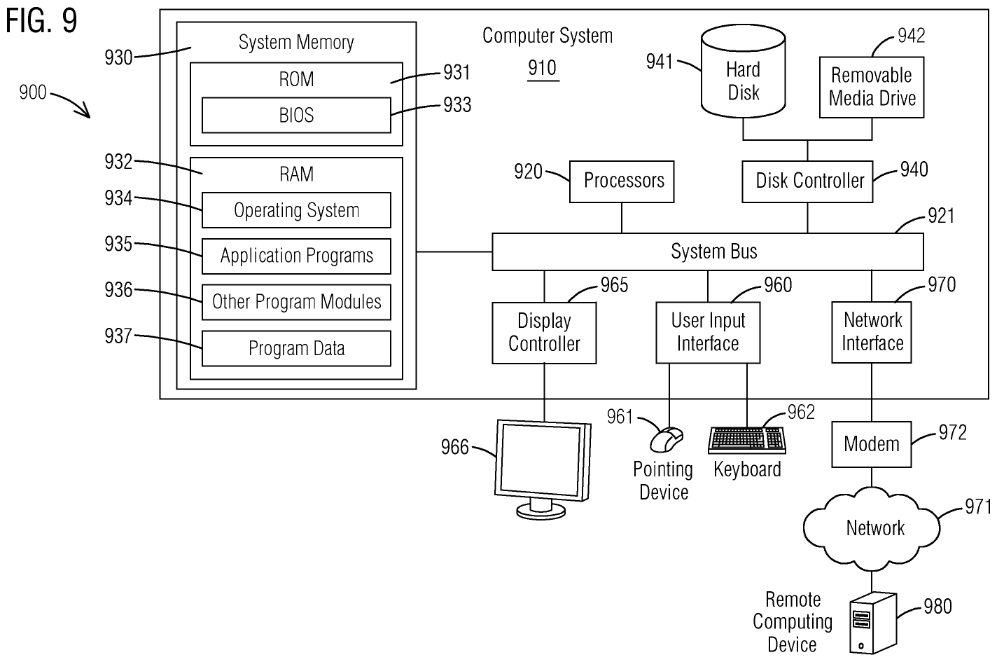

With respect to FIG. 9, it shows an example of a computing environment within which embodiments of the disclosure may be implemented. For example, this computing environment 900 may be configured to execute the system 102 discussed above with reference to FIG. 1 or to execute portions of the method 800 described above with respect to FIG. 8. Computers and computing environments, such as computer system 910 and computing environment 900, are known to those of skill in the art and thus are described briefly here.

As shown in FIG. 9, the computer system 910 may include a communication mechanism such as a bus 921 or other communication mechanism for communicating information within the computer system 910. The computer system 910 further includes one or more processors 920 coupled with the bus 921 for processing the information. The processors 920 may include one or more central processing units (CPUs), graphical processing units (GPUs), or any other processor known in the art.

The computer system 910 also includes a system memory 930 coupled to the bus 921 for storing information and instructions to be executed by processors 920. The system memory 930 may include computer readable storage media in the form of volatile and/or nonvolatile memory, such as read only memory (ROM) 931 and/or random access memory (RAM) 932. The system memory RAM 932 may include other dynamic storage device(s) (e.g., dynamic RAM, static RAM, and synchronous DRAM). The system memory ROM 931 may include other static storage device(s) (e.g., programmable ROM, erasable PROM, and electrically erasable PROM). In addition, the system memory 930 may be used for storing temporary variables or other intermediate information during the execution of instructions by the processors 920. A basic input/output system (BIOS) 933 containing the basic routines that helps to transfer information between elements within computer system 910, such as during start-up, may be stored in ROM 931. RAM 932 may contain data and/or program modules that are immediately accessible to and/or presently being operated on by the processors 920. System memory 930 may additionally include, for example, operating system 934, application programs 935, other program modules 936 and program data 937.

The computer system 910 also includes a disk controller 940 coupled to the bus 921 to control one or more storage devices for storing information and instructions, such as a hard disk 941 and a removable media drive 942 (e.g., floppy disk drive, compact disc drive, tape drive, and/or solid state drive). The storage devices may be added to the computer system 910 using an appropriate device interface (e.g., a small computer system interface (SCSI), integrated device electronics (IDE), Universal Serial Bus (USB), or FireWire).

The computer system 910 may also include a display controller 965 coupled to the bus 921 to control a display 966, such as a cathode ray tube (CRT) or liquid crystal display (LCD), for displaying information to a computer user. The computer system includes an input interface 960 and one or more input devices, such as a keyboard 962 and a pointing device 961, for interacting with a computer user and providing information to the processor 920. The pointing device 961, for example, may be a mouse, a trackball, or a pointing stick for communicating direction information and command selections to the processor 920 and for controlling cursor movement on the display 966. The display 966 may provide a touch screen interface which allows input to supplement or replace the communication of direction information and command selections by the pointing device 1361.

The computer system 910 may perform a portion or all of the processing steps of embodiments of the invention in response to the processors 920 executing one or more sequences of one or more instructions contained in a memory, such as the system memory 930. Such instructions may be read into the system memory 930 from another computer readable medium, such as a hard disk 941 or a removable media drive 942. The hard disk 941 may contain one or more datastores and data files used by embodiments of the present invention. Datastore contents and data files may be encrypted to improve security. The processors 920 may also be employed in a multi-processing arrangement to execute the one or more sequences of instructions contained in system memory 930. In alternative embodiments, hard-wired circuitry may be used in place of or in combination with software instructions. Thus, embodiments are not limited to any specific combination of hardware circuitry and software.

As stated above, the computer system 910 may include at least one computer readable medium or memory for holding instructions programmed according to embodiments of the invention and for containing data structures, tables, records, or other data described herein. The term “computer readable medium” as used herein refers to any medium that participates in providing instructions to the processor 920 for execution. A computer readable medium may take many forms including, but not limited to, non-volatile media, volatile media, and transmission media. Non-limiting examples of non-volatile media include optical disks, solid state drives, magnetic disks, and magneto-optical disks, such as hard disk 941 or removable media drive 942. Non-limiting examples of volatile media include dynamic memory, such as system memory 930. Non-limiting examples of transmission media include coaxial cables, copper wire, and fiber optics, including the wires that make up the bus 921. Transmission media may also take the form of acoustic or light waves, such as those generated during radio wave and infrared data communications.

The computing environment 900 may further include the computer system 910 operating in a networked environment using logical connections to one or more remote computers, such as remote computer 980. Remote computer 980 may be a personal computer (laptop or desktop), a mobile device, a server, a router, a network PC, a peer device or other common network node, and typically includes many or all of the elements described above relative to computer system 910. When used in a networking environment, computer system 910 may include modem 972 for establishing communications over a network 971, such as the Internet. Modem 972 may be connected to bus 921 via user network interface 970, or via another appropriate mechanism.

Network 971 may be any network or system generally known in the art, including the Internet, an intranet, a local area network (LAN), a wide area network (WAN), a metropolitan area network (MAN), a direct connection or series of connections, a cellular telephone network, or any other network or medium capable of facilitating communication between computer system 910 and other computers (e.g., remote computer 980). The network 971 may be wired, wireless or a combination thereof. Wired connections may be implemented using Ethernet, Universal Serial Bus (USB), RJ-11 or any other wired connection generally known in the art. Wireless connections may be implemented using Wi-Fi, WiMAX, and Bluetooth, infrared, cellular networks, satellite or any other wireless connection methodology generally known in the art. Additionally, several networks may work alone or in communication with each other to facilitate communication in the network 971.

In some embodiments, the computer system 910 may be utilized in conjunction with a parallel processing platform comprising a plurality of processing units. This platform may allow parallel execution of one or more of the tasks associated with optimal design generation, as described above. For the example, in some embodiments, execution of multiple product lifecycle simulations may be performed in parallel, thereby allowing reduced overall processing times for optimal design selection.

The embodiments of the present disclosure may be implemented with any combination of hardware and software. In addition, the embodiments of the present disclosure may be included in an article of manufacture (e.g., one or more computer program products) having, for example, computer-readable, non-transitory media. The media has embodied therein, for instance, computer readable program code for providing and facilitating the mechanisms of the embodiments of the present disclosure. The article of manufacture can be included as part of a computer system or sold separately.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

An executable application, as used herein, comprises code or machine readable instructions for conditioning the processor to implement predetermined functions, such as those of an operating system, a context data acquisition system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters.

A graphical user interface (GUI), as used herein, comprises one or more display images, generated by a display processor and enabling user interaction with a processor or other device and associated data acquisition and processing functions. The GUI also includes an executable procedure or executable application. The executable procedure or executable application conditions the display processor to generate signals representing the GUI display images. These signals are supplied to a display device which displays the image for viewing by the user. The processor, under control of an executable procedure or executable application, manipulates the GUI display images in response to signals received from the input devices. In this way, the user may interact with the display image using the input devices, enabling user interaction with the processor or other device.

The functions and process steps herein may be performed automatically or wholly or partially in response to user command. An activity (including a step) performed automatically is performed in response to one or more executable instructions or device operation without user direct initiation of the activity.

The system and processes of the figures are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. As described herein, the various systems, subsystems, agents, managers and processes can be implemented using hardware components, software components, and/or combinations thereof.

Computer readable medium instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, may be implemented by computer readable medium instructions.

It should be appreciated that the program modules, applications, computer-executable instructions, code, or the like depicted in FIG. 9 as being stored in the system memory are merely illustrative and not exhaustive and that processing described as being supported by any particular module may alternatively be distributed across multiple modules or performed by a different module. In addition, various program module(s), script(s), plug-in(s), Application Programming Interface(s) (API(s)), or any other suitable computer-executable code hosted locally on the computer system 910, the remote device, and/or hosted on other computing device(s) accessible via one or more of the network(s), may be provided to support functionality provided by the program modules, applications, or computer-executable code depicted in FIG. 9 and/or additional or alternate functionality. Further, functionality may be modularized differently such that processing described as being supported collectively by the collection of program modules depicted in FIG. 9 may be performed by a fewer or greater number of modules, or functionality described as being supported by any particular module may be supported, at least in part, by another module. In addition, program modules that support the functionality described herein may form part of one or more applications executable across any number of systems or devices in accordance with any suitable computing model such as, for example, a client-server model, a peer-to-peer model, and so forth. In addition, any of the functionality described as being supported by any of the program modules depicted in FIG. 9 may be implemented, at least partially, in hardware and/or firmware across any number of devices.

It should further be appreciated that the computer system 910 may include alternate and/or additional hardware, software, or firmware components beyond those described or depicted without departing from the scope of the disclosure. More particularly, it should be appreciated that software, firmware, or hardware components depicted as forming part of the computer system 910 are merely illustrative and that some components may not be present or additional components may be provided in various embodiments. While various illustrative program modules have been depicted and described as software modules stored in system memory, it should be appreciated that functionality described as being supported by the program modules may be enabled by any combination of hardware, software, and/or firmware. It should further be appreciated that each of the above-mentioned modules may, in various embodiments, represent a logical partitioning of supported functionality. This logical partitioning is depicted for ease of explanation of the functionality and may not be representative of the structure of software, hardware, and/or firmware for implementing the functionality. Accordingly, it should be appreciated that functionality described as being provided by a particular module may, in various embodiments, be provided at least in part by one or more other modules. Further, one or more depicted modules may not be present in certain embodiments, while in other embodiments, additional modules not depicted may be present and may support at least a portion of the described functionality and/or additional functionality. Moreover, while certain modules may be depicted and described as sub-modules of another module, in certain embodiments, such modules may be provided as independent modules or as sub-modules of other modules.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure. In addition, it should be appreciated that any operation, element, component, data, or the like described herein as being based on another operation, element, component, data, or the like can be additionally based on one or more other operations, elements, components, data, or the like. Accordingly, the phrase “based on,” or variants thereof, should be interpreted as “based at least in part on.”

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While embodiments of the present invention have been disclosed in exemplary forms, it will be apparent to those skilled in the art that many modifications, additions, and deletions can be made therein without departing from the spirit and scope of the invention and its equivalents, as set forth in the following claims.

Embodiments and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure embodiments in detail. It should be understood, however, that the detailed description and the specific examples, while indicating preferred embodiments, are given by way of illustration only and not by way of limitation. Various substitutions, modifications, additions and/or rearrangements within the spirit and/or scope of the underlying inventive concept will become apparent to those skilled in the art from this disclosure.

As used herein, the terms “comprises,” “comprising,” “includes,” “including,” “has,” “having” or any other variation thereof, are intended to cover a non-exclusive inclusion. For example, a process, article, or apparatus that comprises a list of elements is not necessarily limited to only those elements but may include other elements not expressly listed or inherent to such process, article, or apparatus.

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms.

In the foregoing specification, the invention has been described with reference to specific embodiments. However, one of ordinary skill in the art appreciates that various modifications and changes can be made without departing from the scope of the invention. Accordingly, the specification and figures are to be regarded in an illustrative rather than a restrictive sense, and all such modifications are intended to be included within the scope of invention.

Although the invention has been described with respect to specific embodiments thereof, these embodiments are merely illustrative, and not restrictive of the invention. The description herein of illustrated embodiments of the invention is not intended to be exhaustive or to limit the invention to the precise forms disclosed herein (and in particular, the inclusion of any particular embodiment, feature or function is not intended to limit the scope of the invention to such embodiment, feature or function). Rather, the description is intended to describe illustrative embodiments, features and functions in order to provide a person of ordinary skill in the art context to understand the invention without limiting the invention to any particularly described embodiment, feature or function. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Respective appearances of the phrases “in one embodiment,” “in an embodiment,” or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the invention.

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

It will also be appreciated that one or more of the elements depicted in the drawings/figures can also be implemented in a more separated or integrated manner, or even removed or rendered as inoperable in certain cases, as is useful in accordance with a particular application.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component.

What is claimed is:

1. A system configured to determine location and sizing of a new power generation or power regulating unit within a current system architecture of a power system including a plurality of power generation units, the system comprising:
a controller including a processor and a memory,
computer-readable logic code stored in the memory which, when executed by the processor, causes the controller to:
execute a hybrid algorithm as a combination of a data-driven algorithm and a model-based algorithm to determine an optimal location and size of the new power generation or power regulating unit,
wherein the data-driven algorithm encodes a location and a size information;
enable the model-based algorithm to optimize performance of a selected location and size of the new power generation or power regulating unit, which is based on a linearized system or a nonlinear system to provide guidance for the data-driven algorithm to incorporate physical rules; and
verify a new system architecture with the new power generation or power regulating unit installation and optimized control parameters to ensure the power system is stable and reliable so that the system can endure a single point failure.

2. The system of claim 1, wherein a power system nonlinear simulator to build up a nonlinear simulation of the power system.

3. The system of claim 2, wherein the model-based algorithm to derive a corresponding linearized system.

4. The system of claim 3, wherein the processor to execute a model-based algorithm engine without new assets including the new power generation or power regulating unit.

5. The system of claim 4, wherein the model-based algorithm engine to send updated models and results of the model-based algorithm to a data-driven algorithm engine.

6. The system of claim 5, wherein the processor to execute the data-driven algorithm engine with a graph-based representation to determine optimal asset locations and sizing incorporating the expert knowledge.

7. The system of claim 6, wherein the data-driven algorithm engine sends an optimized asset location and sizing to the model-based algorithm engine.

8. The system of claim 7, wherein the processor executes the model-based algorithm engine with new asset locations and sizing.

9. The system of claim 8, wherein the processor to send optimized control parameters to the power system nonlinear simulator for simulation and verification.

10. The system of claim 9, wherein the processor to simulate a nonlinear system and send results with system status information back to the model-based algorithm engine.

11. A method of determining location and sizing of a new power generation unit within a current system architecture of a power system comprising a plurality of power generation units, the method comprising:
providing a controller including a processor and a memory,
providing computer-readable logic code stored in the memory which, when executed by the processor, causes the controller to:
iteratively loop between a Reinforcement Learning (RL)-based asset allocation and sizing algorithm which is a data-driven approach and a Dynamic Security Optimization (DSO) algorithm which is a model-based approach to search for an optimal solution via a hybrid approach as a combination of the data-driven approach and the model-based approach such that results of the optimal solution are then verified by a power system nonlinear simulator,
wherein the RL-based asset allocation and sizing algorithm encodes a location and size information in a graph-based representation, and
wherein the RL-based asset allocation and sizing algorithm also incorporates expert knowledge not only for initial selections but allows a workflow that guides the RL-based asset allocation and sizing algorithm to desired locations and size when they are hard to encode;
enable the DSO algorithm which is based on a linearized system to provide guidance for the RL-based asset allocation and sizing algorithm to follow physical rules; and
verify a new system architecture with the new power generation unit installation and optimized control parameters to ensure the power system is stable and reliable during all types of N−1 contingencies so that the power system can endure a single point failure.

12. The method of claim 11, wherein the power system nonlinear simulator to build up a nonlinear simulation of the power system that determines a location and a size of the new power generation unit.

13. The method of claim 12, wherein the DSO algorithm to derive a corresponding linearized system.

14. The method of claim 13, wherein the processor to execute a DSO algorithm engine without new assets including the new power generation unit.

15. The method of claim 14, wherein the DSO algorithm engine to send updated models and results of the DSO algorithm to a RL-based asset allocation and sizing algorithm engine.

16. The method of claim 15, wherein the processor to execute the RL-based asset allocation and sizing algorithm engine with the graph-based representation to determine optimal asset locations and sizing incorporating expert knowledge, wherein the RL-based asset allocation and sizing algorithm engine sends an optimized asset location and sizing to the DSO algorithm engine.

17. The method of claim 16, wherein the processor to:
execute the DSO algorithm engine with new asset locations and sizing;
send optimized control parameters to the power system nonlinear simulator for simulation and verification; and
simulate a nonlinear system and send results with system status information back to the DSO algorithm engine.

18. A system configured to determine location and sizing of a new power generation unit within a current system architecture of a power system comprising a plurality of power generation units, the system comprising:
a controller including a processor and a memory,
computer-readable logic code stored in the memory which, when executed by the processor, causes the controller to:
iteratively loop between a Reinforcement Learning (RL)-based asset allocation and sizing algorithm which is a data-driven approach and a Dynamic Security Optimization (DSO) algorithm which is a model-based approach to search for an optimal solution via a hybrid approach as a combination of the data-driven approach and the model-based approach such that results of the optimal solution are then verified by a power system nonlinear simulator,
wherein the RL-based asset allocation and sizing algorithm encodes a location and size information in a graph-based representation,
wherein the RL-based asset allocation and sizing algorithm also incorporates physical rules not only for initial selections but allows a workflow that guides the RL-based asset allocation and sizing algorithm to desired locations and size when they are hard to encode;
enable the DSO algorithm which is based on a linearized system to provide guidance for the RL-based asset allocation and sizing algorithm to follow the physical rules; and
verify a new system architecture with the new power generation unit installation and optimized control parameters to ensure the power system is stable and reliable during all types of N−1 contingencies so that the power system can endure a single point failure.

19. The system of claim 18, wherein the power system nonlinear simulator to build up a nonlinear simulation of the system.

20. The system of claim 19, wherein the DSO algorithm to derive a corresponding linearized system.
